(19) United States
(12) Patent Application Publication
(10) Pub. No.: US 2018/0315570 A1
(43) Pub. Date: Nov. 1, 2018

(54) CARD STRUCTURE FOR USE IN AN ELECTROMECHANICAL RELAY AND AN ELECTROMECHANICAL RELAY COMPRISING THE CARD STRUCTURE

(71) Applicant: Schneider Electric Asia Pte. Ltd., Singapore (SG)

(72) Inventor: Yijun Pan, Singapore (SG)

(21) Appl. No.: 15/958,716

(22) Filed: Apr. 20, 2018

(30) Foreign Application Priority Data
Apr. 27, 2017 (SG) 10201703450T

(51) Int. Cl. H01H 50/64; H01H 50/04; H01H 50/14; H01H 50/54

(52) U.S. Cl. CPC H01H 50/642; H01H 50/54; H01H 50/14; H01H 50/045

(57) ABSTRACT

An electromechanical relay comprising a card structure having at least one contact portion thereon, the at least one contact portion for contacting at least one electrically conductive member of the electromechanical relay and the at least one contact portion being formed of a material that has a melting point of no less than 400° C.; and an energisable element coupled to the card structure for transmitting a mechanical force to the card structure to displace the electrically conductive member when the energisable element switches from a non-energised state to an energised state.

### TECHNICAL FIELD

The present disclosure relates broadly to a card structure for use in an electromechanical relay and an electromechanical relay comprising the card structure.

### BACKGROUND

An electromechanical relay is typically used to operate machinery and circuits in the electrical/electronics industry. Such relays rely on energisation/de-energisation of an energisable element for operations. The operations may be mediated by a card structure that is configured to move, by function of an energisable element, to close an electrical circuit and to break an electrical circuit.

A significant problem that may arise from such a relay is that because the card structure comes into contact with one or more electrically conductive members, the card structure can be exposed to high temperature. For example, the electrically conductive member may be heated to high temperature by either high current and/or big electrical arc generated when the electromechanical relay switches a big contact load with high operation frequency. Over time, part of the card structure may melt or burn resulting in the deformation of the card structure. Consequently, this undermines the mechanical functionality of the card structure. The electromechanical relay would fail once the card structure is deformed to the extent that it is unable to effectively function to mediate the opening and closing of the circuit(s) controlled by the relay.

In view of the above, there exist a need for a card structure and an electromechanical relay that seek to address or at least ameliorate one of the above problems.

### SUMMARY

According to one aspect, there is provided an electromechanical relay comprising a card structure having at least one contact portion thereon, the at least one contact portion for contacting at least one electrically conductive member of the electromechanical relay and the at least one contact portion being formed of a material that has a melting point of no less than 400° C.; and an energisable element coupled to the card structure for transmitting a mechanical force to the card structure to displace the electrically conductive member when the energisable element switches from a non-energised state to an energised state.

In one embodiment, the energisable element is coupled to the card structure at one end of the card structure and the at least one of the contact portion contacts the electrically conductive member at an opposite end of the card structure.

In one embodiment, at least one of the electrically conductive member or the card structure comprises an aperture such that the contact between part of the electrically conductive member and the part of the card structure occurs within the aperture.

In one embodiment, said part of the electrically conductive member is disposed in an aperture of the card structure.

In one embodiment, said part of the card structure is disposed in an aperture of the electrically conductive member.

In one embodiment, the card structure is arranged such that when the energisable element switches from a non-energised state to an energised state, said part of the electrically conductive member remains within the aperture of the card structure throughout the displacement of the electrically conductive member.

In one embodiment, the card structure is arranged such that when the energisable element switches from a non-energised state to an energised state, said part of the card structure remains within the aperture of the electrically conductive member throughout the displacement of the electrically conductive member.

In one embodiment, wherein the card structure is arranged such that displacement of the electrically conductive member comprises a rotational displacement.

In one embodiment, switching of the energisable element from a non-energised state to an energised state corresponds to a change in connection status of a circuit arranged to be completed by said electrically conductive member.

In one embodiment, the card structure comprises two contact portions thereon, each of the two contact portions being disposed on opposite sides of a line of symmetry of the card structure.

In one embodiment, the card structure further comprises a first engagement structure and the electromechanical relay further comprises a second engagement structure disposed on a base of the electromechanical relay, the first and second engagement structure configured to engage with each other such that card structure is guided to move substantially along a single axis when the energisable element switches from a non-energised state to an energised state.

In one embodiment, at least one contact portion is formed of a material selected from a group consisting of ceramic, glass, cemented carbide and combinations thereof.

According to another aspect, there is provided a card structure for use in an electromechanical relay disclosed herein, the card structure comprising at least one contact portion for contacting at least one electrically conductive member of the electromechanical relay, wherein the at least one contact portion is formed of a material that has a melting point of no less than 400° C.

In one embodiment the card structure, other than the at least one contact portion, is formed of a material that is different from the at least one contact portion.

In one embodiment, the card structure, other than the at least one contact portion, is formed of a material that has a melting point that is less than 350° C.

In one embodiment, the card structure, other than the at least one contact portion, is formed of a polymeric material.

In one embodiment, the at least one contact portion is formed of a material selected from a group consisting of ceramic, glass, cemented carbide and combinations thereof.

In one embodiment, the at least one contact portion forms at least part of a circumference that defines an aperture of the card structure.

In one embodiment, the contact portion is dimensioned to substantially prevent the electrically conductive member of the electromechanical relay from contacting any other part of the card structure when in use.

In one embodiment, the contact portion is a detachable component of the card structure.

In one embodiment, the card structure comprises two contact portions thereon, each of the two contact portions being disposed on opposite sides of a line of symmetry of the card structure.

In one embodiment, the card structure is substantially free of polymeric material polyamide 6T and polyphenylene sulfide (PPS).

In one embodiment, the card structure further comprises a first engagement structure for engaging a second engagement structure disposed on a base of an electromechanical relay such that the card structure is guided to move substantially in a single direction when an energisable element of the electrometrical relay switches from a non-energised state to an energised state.

### BRIEF DESCRIPTION OF THE DRAWINGS

FIG. 1A is a schematic drawing of a perspective view of an electromechanical relay comprising a card structure in accordance with an example embodiment disclosed herein.

FIG. 1B is a schematic drawing of a side view of the electromechanical relay of FIG. 1A.

FIG. 1C is a schematic drawing of the opposite side view of the electromechanical relay of FIG. 1B.

FIG. 1D is a schematic drawing of a top plan view of the electromechanical relay of FIG. 1A.

FIG. 1E is a schematic drawing of an end view of the electromechanical relay of FIG. 1A.

FIG. 2A is a schematic drawing of a perspective view of the card structure of FIGS. 1A-1E.

FIG. 2B is a schematic drawing of a top plan view of the card structure of FIG. 2A.

FIG. 2C is a schematic drawing of a bottom plan view of the card structure of FIG. 2A.

FIG. 2D is a schematic drawing of a side view of the card structure of FIG. 2A.

FIG. 3A is a schematic drawing of a contact portion of the card structure of FIG. 2A.

FIG. 3B is a schematic drawing of a side view of the contact portion of FIG. 3A.

FIG. 4A shows a deformed contact portion of a card structure that does not comply with one or more of the requirements of embodiments disclosed herein.

FIG. 4B shows a melted contact portion of a card structure that does not comply with one or more of the requirements of embodiments disclosed herein.

### DETAILED DESCRIPTION

Example embodiments of the disclosure will be better understood and readily apparent to one of ordinary skill in the art from the following discussions and if applicable, in conjunction with the figures. It should be appreciated that other modifications related to structural, electrical and material changes may be made without deviating from the core of the disclosure. Example embodiments are not necessarily mutually exclusive as some may be combined with one or more embodiments to form new exemplary embodiments.

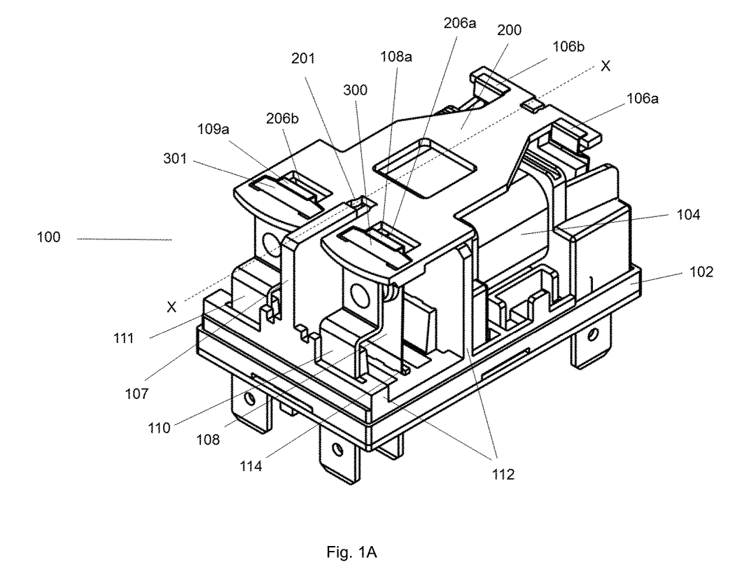

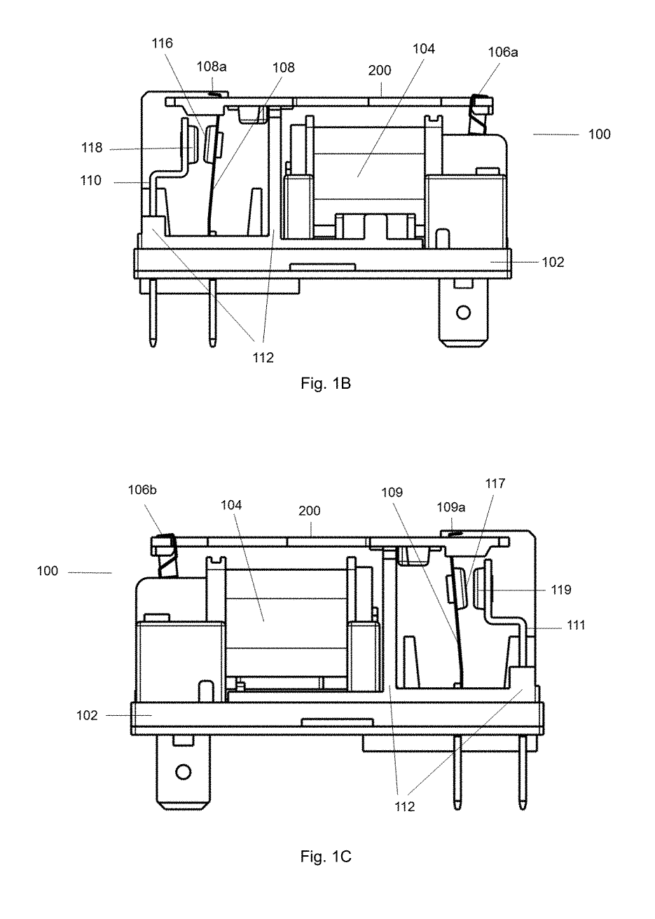

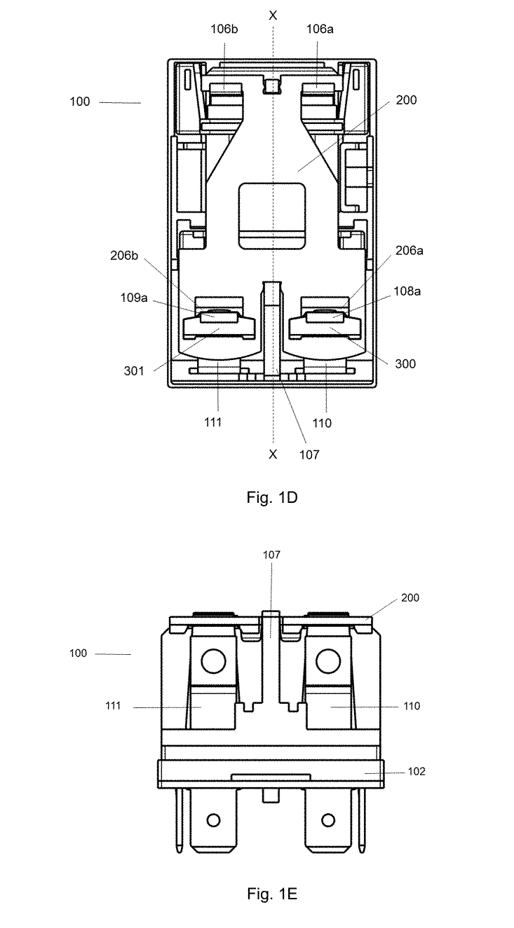

FIGS. 1A-1E show different views of an electromechanical relay 100 comprising a card structure 200 in accordance with an example embodiment disclosed herein. In the example embodiment, the electromechanical relay 100 comprises a base 102, an energisable element 104, one or more armatures 106a and 106b, a card structure 200, an electrically conductive member in the form of a movable blade 108 having a movable contact 116 thereon and a fixed terminal 110 having a fixed contact 118 thereon. In the embodiment, the energisable element 104 comprises coils. It may be appreciated that 106a and 106b may be separate armatures, or parts of the same armature.

The base 102 comprises supporting structures 112 extending therefrom for receiving the fixed terminal 110. Normally, the energisable element 104, the movable blade 108 and the fixed terminal 110 are fixed to the base 102. Normally, the one or more armatures 106a and 106b is/are connected to the energisable element 104 by a hinge connection. The supporting structures 112 also provide a supporting platform for the card structure 200 such that the card structure 200 is maintained at a substantially horizontal position along the X-axis represented by a dotted line X. Additionally, an engagement structure (disposed on the base 102 of the electromechanical relay 100), in the form of a fin 107 extends from the base 102 that serves to restrict the movement of the card structure 200 within the electromechanical relay 100.

In the example embodiment, the card structure 200 is coupled to the energisable element 104 at a position that is proximal to the one or more armatures 106a and 106b. In particular, the card structure 200 is in fitting contact with the one or more armatures 106a and 106b at one end and is coupled to the movable blade 108 at the other/opposite proximal end via the contact portion 300 of the card structure 200. The contact portion 300 of the card structure 200 is in contact with the part 108a of the movable blade 108. The part 108a is shaped/bent to allow latching onto the contact portion 300. Advantageously, these configurations provide a more secure/reliable contact. Consequently, the coupling between the card structure 200 and the movable blade 108 is enhanced.

The part 108a of the movable blade 108 is disposed within an aperture 206a of the card structure 200 when in contact with the contact portion 300. As may be appreciated, in an alternative design, the aperture may alternatively be on the movable blade 108, in which case, a part of the card structure 200 will be disposed within the aperture of the movable blade 108. The movable blade 108 is in contact with the contact portion 300 at one end and is fixedly/securely coupled to the supporting structures 112 at the other end, for example, by fitting the other end of the movable blade 108 into a receiving guide 114 in the supporting structure 112, thereby forming a cantilever-type arrangement with one substantially free end and another fixed/secured end. The movable blade 108 is situated substantially close to, and biased towards the fixed terminal 110 to allow more efficient mutual interactions to take place during energisation/de-energisation events.

The energisable element 104 is configured to transmit a mechanical force to the card structure 200 to displace the movable contact 116 which is riveted into the movable blade 108 when the energisable element 104 switches from a non-energised state to an energised state or vice versa. In the example embodiment, when the energisable element 104 is in a non-energised state, the card structure 200 is configured to have an opposing force against movable blade 108 biased towards the fixed terminal 110 by way of contact between the contact portion 300 of the card structure 200 and part 108a of the movable blade 108 latched thereon. When the energisable element 104 is in an energised state, the card structure 200 is configured to release at least a portion of the part 108a latched on the contact portion 300 such that the opposing force on the part 108a is reduced/removed, and the movable blade 108 is allowed to displace towards the fixed terminal 110 so that the movable contact 116 makes contact with the fixed contact 118.

In the example embodiment, when the energisable element 104, for example an electromagnet, in the electromechanical relay 100 is energised, i.e. when the coil is powered ON, a force, for example, a magnetic force, causes the one or more armatures 106a and 106b, which is/are pivoted at one end by way of a hinge connection to the energiser element 104, to rotate towards the energisable element 104. When the energisable element 104 is de-energised, i.e. when the coil is powered OFF, the one or more armatures 106a and 106b return(s) to its default upright position. The card structure 200, which is in fitting contact with the one or more armatures 106a and 106b, is/are pushed or pulled along the X-axis (represented by the dotted line X) with the rotation of the one or more armatures 106a and 106b. Accordingly, in the example embodiment, the card structure 200 is a movable component of an electromechanical relay 100. When the energisable element 104 is energised, the one or more armatures 106a and 106b push(es) or produce(s) a translational movement of the card structure 200 to reduce/release the opposing force on part 108a of the movable blade 108 by the contact portion 300. This allows an upper end of the movable blade 108, which is in a cantilever-type arrangement and which is biased towards the fixed terminal 110, to displace towards the fixed terminal 110 so that the movable contact 116 makes contact with the fixed contact 118. The contact is enabled by a spring force from the stiff movable blade 108. When the energisable element 104 is de-energised, the one or more armatures 106a and 106b pull(s) or produce(s) a translational movement of the card structure 200 which will in turn pull or produces a translational movement of the movable blade 108 to break the contact between the movable contact 116 and the fixed contact 118. The movable blade 108 is thus enabled to displace forward connect the movable contact 116 to the fixed contact 118 of the fixed terminal 110, and backward to disconnect the movable contact 116 from the fixed contact 118 of the fixed terminal 110 by virtue of its coupling to the card structure 200. Therefore, in some instances, the card structure 200 may also be known as a push card as it pushes the movable blade 108 to connect or disconnect the movable contact 116 from the fixed contact 118 of the fixed terminal 110. It will be appreciated that the movable blade 108 having a movable contact 116 thereon is a flexible part whilst the fixed terminal 110 having a fixed contact 118 thereon is a static part. It will also be appreciated that the card structure 200 is a mechanical part that transfers movement from the one or more armatures 106a and 106b to the movable contact 116.

In the example embodiment, the card structure 200 is arranged such that when the energisable element 104 switches from a non-energised state to an energised state, at least part of the movable blade 108a remains within the aperture 206a throughout the displacement of the movable blade 108a. Advantageously, such an arrangement may prevent/avoid or minimise the occurrence of decoupling between the card structure 200 and the movable blade 108. In the example embodiment, the switching of the energisable element 104 from a non-energised state to an energised state corresponds to a change in connection status of a circuit arranged to be completed by the movable blade 108.

In the example embodiment, the fin 107 is being configured to fit into/engage with an engagement structure (of the card structure 200), in the form of a slot 201 of the card structure 200 such that card structure 200 is guided to move substantially along a single axis (represented by dotted line X) or single direction when the energisable element switches from a non-energised state to an energised state or vice versa. Therefore, the slot 201 works like a track to allow guided movement of the card structure 200 and substantially prevents the card structure 200 from moving out of its intended course or position (which may possibly result in malfunction of the relay) during energisation/de-energisation events. Detraction of the card structure 200 out of its intended position or course may in certain cases result in undesired contact of the movable blade 108 with parts of the card structure 200 that are not part of the contact portion 300. It will be appreciated that although in the example embodiment, the fin 107 is a structure extending from the base 102 and the slot 201 is part of the card structure 200, the configurations may be reversed such that the fin becomes part of the card structure and the slot becomes a structure of the base, to collectively still achieve the effect of guided movement of the card structure. Other configurations involving different engaging structures/members on both the base and the card structures may also be adopted.

In the example embodiment illustrated in FIGS. 1A-1E, the card structure 200 is coupled to a normally-open (NO) fixed terminal 110. It will be appreciated that in some embodiments, the electromechanical relay 100 may be configured to couple the card structure 200 to a normally-closed (NC) fixed terminal.

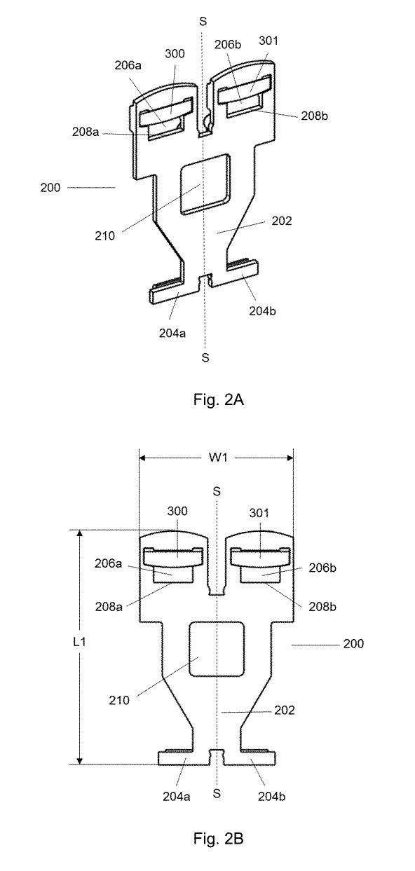

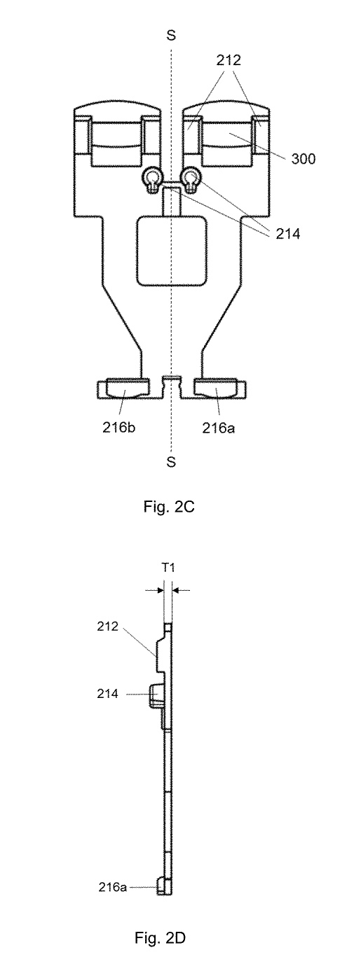

FIGS. 2A-2D are schematic drawings showing different views of the card structure 200 of FIGS. 1A-1E. In the example embodiment, the card structure 200 has an extended flat body 202 and has two arms 204a and 204b extending outwards from one end of the main body. Each of the two arms 204a and 204b comprises a bracket 216a and 216b respectively, for coupling/engaging with the one or more armatures 106a and 106b shown in FIGS. 1A-1E. At the other proximal end, the card structure 200 has two apertures 206a and 206b having circumferences 208a and 208b for coupling with one or more movable blade 108 shown in FIGS. 1A-1E. The contact portion 300 forms at least part of the circumference 208a that defines the aperture 206a. The contact portion 300 is supported from its underside, at its two ends, by two flanges 212. The two supported ends of the contact portion are adjacent to portion of the contact portion that forms at least part of the circumference 208a. The card structure has two projections 214 such that when the card structure 200 moves in the direction towards the one or more armatures 106a and 106b along the X-axis (represented by dotted line X) shown in FIG. 1A and FIG. 1D, continual movement in the same direction becomes blocked when the projections 214 contact part of the supporting structure 112 shown in FIG. 1A, thereby restricting the amount of translational movement allowable to the card structure 200.

In the example embodiment, the length L1 of the card structure 200 is about 43.2 mm, the width W1 of the card structure 200 is about 28.2 mm, and the thickness T1 of the card structure 200 is about 1.1 mm.

In the example embodiment, the card structure 200 has a line of symmetry represented by a dotted line S. The portions of the card structure 200 on opposite sides of the line of symmetry are mirror images of each other. For example, the arms 204a and 204b are mirror images of each other, the two apertures 206a and 206b are mirror images of each other, the circumferences 208a and 208b are mirror images of each other, and the brackets 216a and 216b are mirror images of each other. In the example embodiment, there are two contact portions 300 and 301, each of the two contact portions are similar to each other and are being disposed on opposite sides of a line of symmetry of the card structure 200. Accordingly, as shown in FIGS. 1A-1E, some parts of the relay 100 may be mirror images of each other as well for respectively cooperating with the corresponding mirror image equivalents of the different parts of the card structure 200. For example, the fixed terminal 110 having a fixed contact 118 thereon has a mirror image equivalent represented as a fixed terminal 111 having a fixed contact 119 thereon, the movable blade 108 having a movable contact 116 thereon has a mirror image equivalent represented as movable blade 109 having a movable contact 117 thereon, and part 108a has a mirror image equivalent represented as part 109a, which is disposed in aperture 206b (i.e. the mirror image equivalent of aperture 206a). It will be appreciated that in various other embodiments, parts 108a and 109a may be parts of the same movable blade or may be parts of two different movable blades. As such, it will also be appreciated that in various other embodiments, parts 108 and 109a may serve to connect/disconnect the same or different circuits. Advantageously, these configurations potentially enable the displacement of a single card structure to control the switching on/off of multiple circuits.

It will be appreciated that although in the example embodiment, two contact portions 300 and 301 are used, other number of contact portions may be used. For example, 1, 2, 3, 4 or 5 non-conductive contact portions may be employed in various embodiments.

In the example embodiment, the card structure 200, other than the contact portion 300, is formed of a material that is different from the contact portion 300. The material may have a melting point that is less than about 400° C., less than about 350° C. or less than about 300° C. In particular, in the example embodiment, the contact portion 300 is made of ceramic comprising aluminum oxide (Al₂O₃) while the other parts of the card structure is made of engineering plastics. In the example embodiment, the other parts of the card structure is made of low/normal grade engineering plastic polyamide such as PA 2200 that typically has a low melting temperature as compared to high grade engineering plastic such as PA6T. Advantageously, the contact portion 300 is able to withstand high temperatures such as those caused by high current and/or big electrical arc generated via the movable blade 108. As such, the contact portion 300 can substantially retain its structure and integrity with little or no appreciable deformation over long periods of use. Advantageously, the other parts of the card structure are made of PA 2200 are relatively cheap and easy to shape and manufacture. This can beneficially drive down the costs of production of the card structure.

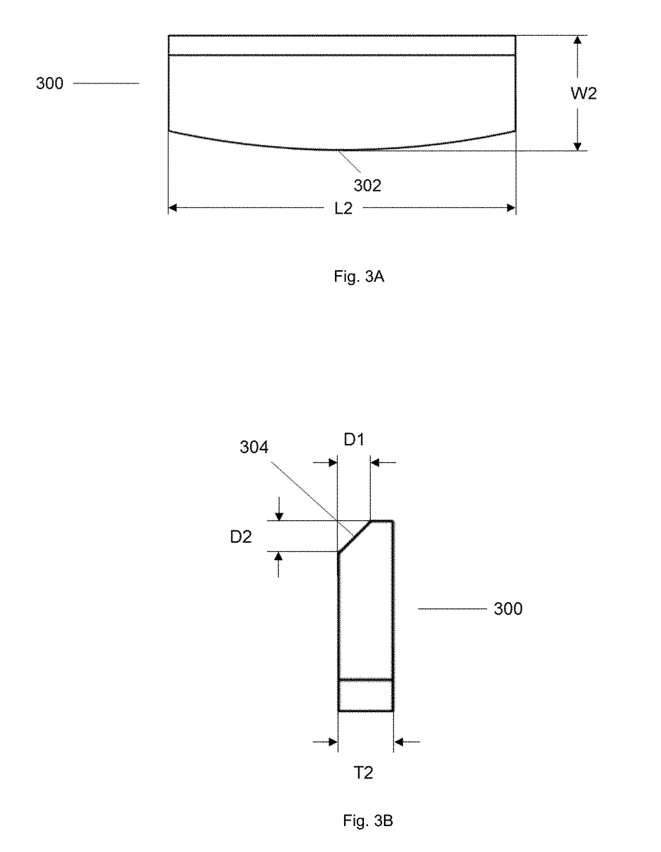

FIGS. 3A and 3B are schematic drawings showing different views of the contact portion 300 shown in FIGS. 1A-1E and FIGS. 2A-2D. In the example embodiment, the contact portion 300 is dimensioned to substantially prevent the movable blade 108 of the electromechanical relay 100 from contacting any other part of the card structure 200 when in use. In the example embodiment, the length L2 of the contact portion 300 is about 10.7±0.3 mm, the width W2 of the contact portion 300 is about 3.5±0.2 mm and the thickness T2 of the contact portion 300 is about 1.0±0.1 mm. The side 302 of the contact portion 300 that directly contacts the movable blade 108 is curved for substantially the full length. Advantageously, the curved surface may create point contact or reduce the area of contact between the contact portion 300 and the movable blade 108 such that thermal transfer from the movable blade 108 to the contact portion 300 is reduced. With reference to the orientation of the card structure 200 in an electromechanical relay 100 in FIG. 1A, at least a top half portion 304 of the curved side 302 is inclined at an angle i.e. having a chamfered edge. In the example embodiment, the dimension D1 of the chamfered edge is about 0.6 mm and the dimension D2 of the chamfered edge is about 0.6 mm. Advantageously, the chamfered/contoured edges of the contact portion 300 may facilitate smooth and efficient coupling with the movable blade 108.

In the example embodiment, the contact portion 300 is made of ceramic comprising Al₂O₃ which has a melting temperature of about 2054° C. and a relative temperature index of about 1680° C. Advantageously, the contact portion 300 is able to withstand high temperatures such as those caused by high current and/or big electrical arc generated via the movable blade 108. As such, the contact portion 300 can substantially retain its structure and integrity with little or no appreciable deformation over long periods of use even when it is in direct contact with an electrical live part of the relay.

Advantageously, the electromechanical relay comprising a card structure 200 according to the example embodiment described above can withstand at least about 100,000 normal operating cycles without the contact portion 300 of the card structure 200 substantially softening, breaking, cracking, melting, burning and/or deforming. Typically, an electromechanical relay is expected to meet the industrial standard requirement of 100,000 cycles of electrical endurance, the electrical endurance test being conducted at the rated contact load of the electromechanical relay, i.e. the maximum voltage and current the relay can continuously carry within a prescribed temperature limit, at an upper limiting ambient temperature and at a specific operating frequency. Advantageously, the electromechanical relay comprising a card structure 200 according to the example embodiment described above shows improvement in the maximum contact current, the upper limiting ambient temperature and the number of operating cycles in an electrical endurance test as compared to an electromechanical relay that does not comply with one or more of the requirements of embodiments disclosed herein (for example a card structure having similar properties as conventional card structures in the art). The example embodiment may withstand at least about 100,000, at least about 200,000, or at least about 300,000 operating cycles at an ambient temperature of about 55° C., a rated (coil) voltage of about 230 VAC, a contact load of about 24 VDC, 40 A, an operation frequency of about 0.5 s ON, 0.5 s OFF and a duty cycle of 50%. Advantageously, an electromechanical relay comprising a card structure in accordance with embodiments described herein may also have improved relay contact reliability, improved product life, improved contact switching capacity, improved operating frequency and/or improved contact duty cycle. For example, relay contact reliability is improved as the problem of the contact portion softening, melting or burning is resolved or at least ameliorated. For example, relay product life is improved as the number of operating cycles can increase to beyond 100,000.

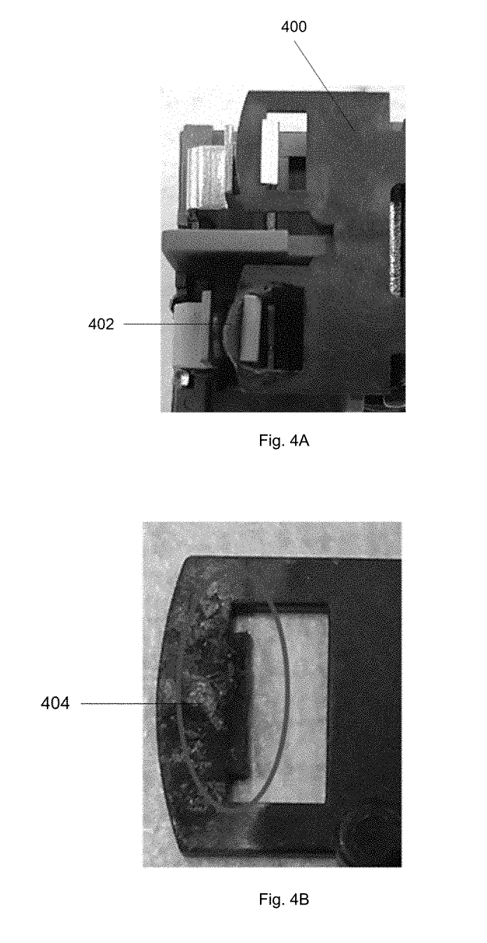

FIG. 4A and FIG. 4B show a contact portion of a card structure 400 that does not comply with one or more of the requirements of embodiments disclosed herein. For example, FIG. 4A and FIG. 4B may be representative of a card structure having similar properties as conventional card structures in the art. The contact portion 402 has become deformed. Part of the contact portion 404 has melted. The contact portion is formed of the material polyamide 6T (PA6T). Notably, although PA6T is a type of very high grade engineering plastic material, a contact portion formed of PA6T may still melt after a certain number of operating cycles, for example after no more than 100,000 operating cycles or after no more than the number operating cycles that an electromechanical relay according to an example embodiment disclosed herein can undergo at specific operating conditions before failing. Without being bound by any particular theory, the melting of a PA6T contact portion may be attributed to high contact current and/or voltage which generated substantial heat and/or electrical arc. Without being bound by any particular theory, the melting of a PA6T contact portion may also be related to the specific operation frequency, duty cycle and/or ambient temperature that was used or how the electrometrical relay was installed.

### Comparative Example

To determine how the performance of an electromechanical relay according to an example embodiment disclosed herein match up against an electromechanical relay that does not comply with one or more of the requirements of embodiments disclosed herein (for example a card structure having similar properties as conventional card structures in the art), a comparative test is carried out. In this test, 5 representative samples from each group (i.e. the first group being an electromechanical relay having the contact portion of the card structure made of Al₂O₃ and the remaining of the card structure made up of PA 2200; the second group being an electromechanical relay has a card structure entirely made up of PA6T) were selected and each sample was assessed for the number of cycles it can operate before it fails under the following testing conditions: an ambient temperature of about 55° C., a rated (coil) voltage of about 230 VAC, a contact load of about 24 VDC, 40 A, an operation frequency of about 0.5 s ON, 0.5 s OFF and a duty cycle of 50%. Notably, the contact current (40 A) used in this test is higher that the contact current (30 A) typically used for a conventional relay. A sample is considered to have failed if it shows 2 consecutive contact failures or a total of 5 contact failures during the test.

The test results reveal that, the samples from the first group showed an average 32.8% improvement in terms of number of operating cycles as compared to the samples of the second group. Accordingly, the test results demonstrate that an electromechanical relay according to an example embodiment disclosed herein is capable of having an improved performance when compared to an electromechanical relay that does not comply with one or more of the requirements of embodiments disclosed herein (for example a card structure having similar properties as conventional card structures in the art). Notably, such improvement in performance is still possible even when the the card structure of the first group of samples, other than the contact portion, is formed of the material polyamide (PA) 2200 which has a low melting point of about 172° C. to about 180° C. as opposed to the card structure of the second group of samples, which is wholly formed of the material PA6T which has a higher melting point of about 320° C. to about 330° C.

Therefore, it is evident that at specific operating conditions such as a specific contact current, an electromechanical relay according to an example embodiment disclosed herein is able to advantageously withstand more operating cycles before it fails as compared to a conventional relay. To complete the same number of operating cycles without failing, an electromechanical relay according to an example embodiment disclosed herein can withstand a higher contact current as compared to a conventional relay. An electromechanical relay according to an example embodiment disclosed herein also has a higher switching capacity as compared to a conventional relay. Parts of the contact portions of the comparative example were observed to melt during the test. When subject to the same operating conditions therefore, an electromechanical relay according to an example embodiment disclosed herein is superior over a conventional relay in that its contact portions do not any show appreciable deformation, melting or softening.

When describing embodiments of the card structure herein, references to different features have been made. It will be appreciated that one or more of these features may be formed as part of the entire card structure or may be individual components that are later fitted or added to other individual components to collectively form the card structure. For example, in some embodiments, the contact portion that forms at least part of the circumference that defines the aperture may be a separate component that is attached to the circumference of the aperture, whether removably/detachably or otherwise. In other embodiments, the contact portion may be an integrated part of the entire card structure. For example, the contact portion may be part of a unibody card structure. In some embodiments, where the contact portion is a removable/detachable component of the card structure, the contact portion may be adhered to the card structure by mechanical means or chemical means. Mechanical means may include relying on physical structures that can securely engage the contact portion to the card structure. Chemical means may include the use of adhesives or the like to adhere the contact portion to the card structure.

It will be appreciated that in various other embodiments, the card structure can assume alternative shapes and can contain no aperture, or one or more apertures so long as it may allow the electrically conductive member to be displaced by way of a transmission of a mechanical force from the energisable element to the card structure during the energisation or de-energisation of the energisable element of the relay.

It will be appreciated that, the card structure disclosed herein can also assume other material that is also capable of carrying out its intended purposes described above. For example, other than the contact portion, the card structure may be substantially free of a material that has a melting point of about 200° C. and above. In other embodiments, the card structure, other than the contact portion, is formed of a polymeric material. In other embodiments, the card structure, other than the contact portion, is substantially free of a polymeric material that has a relative temperature index of about 120° C., about 130° C., about 140° C., about 150°, or about 160° C. and above when tested at a thickness of 0.75 mm based on the UL 746 test method. For example, the card structure, other than the contact portion, may be substantially free of the polymeric material PA6T and/or polyphenylene sulfide (PPS).

It will be appreciated that, the contact portion of the card structure can also assume other material that is also capable of carrying out its intended purposes described above. For example, the contact portion may be formed of a material that has a melting point of no less than about 2000° C., no less than about 1900° C., no less than about 1800° C., no less than about 1700° C., no less than about 1600° C., no less than about 1500° C., no less than about 1400° C., no less than about 1300° C., no less than about 1200° C., no less than about 1100° C., no less than about 1000° C., no less than about 900° C., no less than about 800° C., no less than about 700° C., no less than about 600° C., no less than about 500° C. or no less than about 400° C.

In some embodiments, the contact portion is formed of a material that is non-electrically conductive and/or non-magnetic and/or substantially heat resistant. In some embodiments, the contact portion is formed of a material that has substantially high strength when compared to polymers such as polyamides, low/normal grade engineering plastics such as PA 2200 and/or high grade engineering plastics such as PA6T and PPS. In some embodiments, the contact portion is formed of a material that has substantially high insulation to heat as compared to polymers such as polyamides, low/normal grade engineering plastics such as PA 2200 and/or high grade engineering plastics such as PA6T and PPS. In an example embodiment, the contact portion is formed of a material that has substantially high resistance to heat as compared to polymers such as polyamides, low/normal grade engineering plastics such as PA 2200 and/or high grade engineering plastics such as PA6T and PPS. In an example embodiment, the contact portion is formed of a material that has substantially low thermal conductivity as compared to polymers such as polyamides, low/normal grade engineering plastics such as PA 2200 and/or high grade engineering plastics such as PA6T and PPS.

In some embodiments, the contact portion is formed of a composite material. In various embodiments, the composite material is selected from the group consisting of a polymer matrix composite, a metal-matrix composite or a ceramic-matrix composite. In some embodiments, the polymer matrix composite is selected from polymer, thermoset and thermoplastic. In some embodiments, the metal-matrix composite comprises cemented carbide. In some embodiments, the ceramic-matrix composite is selected from ceramic and glass. In some embodiments, the contact portion comprises an inorganic oxide. In some embodiments, the inorganic oxide is selected from aluminum oxide and glass. In some embodiments, the contact portion is formed of a material selected from a group consisting of ceramic, glass, cemented carbide and combinations thereof. In some embodiments, the contact portion is ceramic containing aluminum oxide.

It will be appreciated that when the card structure disclosed herein comprises parts that are made of polymers, the parts that are made of polymers may be formed by conventional engineering techniques such as plastic moulding or the like. When the card structure disclosed herein comprises parts that are made of inorganic oxides such as ceramics or glass, conventional machining techniques to shape inorganic oxides may be employed. Further possible techniques that may be employed to make the card structure or parts of the card structure include die casting, injection moulding, metal stamping, machining, powder metallurgy or the like.

In some embodiments, the electromechanical relay is capable of undergoing at least about 100,000, about 200,000 or about 300,000 operating cycles (for example, each operating cycle may comprise an energisation event and a de-energisation event) at a higher contact current (for example more than 30 A, or 40 A and above) without any appreciable deformation, or melting, burning, breaking, softening or cracking of the contact portion of the card structure.

It will be appreciated that in some embodiments, the electromechanical relay can be configured such that when the energisable element is energised, the armature rotates away from the energisable element and when the energisable element is de-energised, the armature returns to its default upright position, with the electromechanical relay still achieving an intended function of controlling the closing and breaking an electrical circuit in such a configuration.

In some embodiments, the electromechanical relay comprises a card structure having at least one contact portion thereon, the at least one contact portion for contacting at least one electrically conductive member of the electromechanical relay and the at least one contact portion being formed of a material that has a melting point of no less than 400° C. In some embodiments, the electromechanical relay comprises an energisable element coupled to the card structure for transmitting a mechanical force via/to the card structure to displace the electrically conductive member when the energisable element switches from a non-energised state to an energised state. In some embodiments, at least one of the electrically conductive member or the card structure of the electromechanical relay comprises an aperture such that the contact between part of the electrically conductive member and the part of the card structure occurs within the aperture. In some embodiments, said part of the electrically conductive member is disposed in an aperture of the card structure. In some embodiments, said part of the card structure is disposed in an aperture of the electrically conductive member. Accordingly, in some embodiments, the card structure is arranged such that when an energisable element switches from a non-energised state to an energised state, at least part of the card structure remains within the aperture of the electrically conductive member throughout the displacement of the electrically conductive member.

In some embodiments, the card structure is arranged such that displacement of the electrically conductive member comprises a rotational displacement of one end of the electrically conductive member. As compared to a translational displacement of the entire electrically conductive member, a rotational displacement of one end of the electrically conductive member in a cantilever-type arrangement by a reduction/release of an opposing force on the electrically conductive member may be effected by a relatively smaller mechanical force and is thus more energy efficient. Further, a rotational displacement of one end of the electrically conductive member, as compared to a translational displacement of the entire electrically conductive member, may also be beneficial in constrained spaces such as that within a relay. This may also be effective in allowing the relay to be kept compact. In some embodiments, the card structure comprises at least one contact portion for contacting at least one electrically conductive member of the electromechanical relay, wherein the at least one contact portion is formed of a material that has a melting point of no less than 400° C. In some embodiments, the card structure comprises a first engagement structure for engaging a second engagement structure disposed on a base of an electromechanical relay such that the card structure is guided to move substantially in a single direction when an energisable element of the electrometrical relay switches from a non-energised state to an energised state.

In some embodiments, the energisable element is coupled to the card structure at one end of the card structure and the at least one of the contact portion contacts the electrically conductive member at an opposite end of the card structure. Advantageously, this configuration allows for efficient displacement of the electrically conductive member by way of the energisable element transmitting a mechanical force to the card structure.

The terms “coupled” or “connected” as used in this description are intended to cover both directly connected or connected through one or more intermediate means, unless otherwise stated.

The term “electrically non-conductive” used in this description is not intended to be an absolute term that cover only cases that totally exclude any measure of electrical conductivity. The term should be understood based on the relevant context and may include cases where some electrical conductivity can present albeit in amounts that are not meaningful or useful for that context. Terms phrased in a similar manner should also be interpreted accordingly.

The term “adjacent” used herein when referring to two elements refers to one element being in close proximity to another element and may be but is not limited to the elements contacting each other or may further include the elements being separated by one or more further elements disposed therebetween.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

It will be appreciated by a person skilled in the art that other variations and/or modifications may be made to the specific embodiments without departing from the spirit or scope of the invention as broadly described. The present embodiments are, therefore, to be considered in all respects to be illustrative and not restrictive.

1. An electromechanical relay comprising
a card structure having at least one contact portion thereon, the at least one contact portion for contacting at least one electrically conductive member of the electromechanical relay and the at least one contact portion being formed of a material that has a melting point of no less than 400° C.; and
an energisable element coupled to the card structure for transmitting a mechanical force to the card structure to displace the electrically conductive member when the energisable element switches from a non-energised state to an energised state.

2. The electromechanical relay of claim 1, wherein the energisable element is coupled to the card structure at one end of the card structure and the at least one of the contact portion contacts the electrically conductive member at an opposite end of the card structure.

3. The electromechanical relay of claim 1, wherein at least one of the electrically conductive member or the card structure comprises an aperture such that the contact between part of the electrically conductive member and the part of the card structure occurs within the aperture.

4. The electromechanical relay of claim 3, wherein said part of the electrically conductive member is disposed in an aperture of the card structure.

5. The electromechanical relay of claim 3, wherein said part of the card structure is disposed in an aperture of the electrically conductive member.

6. The electromechanical relay of claim 4, wherein the card structure is arranged such that when the energisable element switches from a non-energised state to an energised state, said part of the electrically conductive member remains within the aperture of the card structure throughout the displacement of the electrically conductive member.

7. The electromechanical relay of claim 5, wherein the card structure is arranged such that when the energisable element switches from a non-energised state to an energised state, said part of the card structure remains within the aperture of the electrically conductive member throughout the displacement of the electrically conductive member.

8. The electromechanical relay of claim 1, wherein the card structure is arranged such that displacement of the electrically conductive member comprises a rotational displacement.

9. The electromechanical relay of claim 1, wherein switching of the energisable element from a non-energised state to an energised state corresponds to a change in connection status of a circuit arranged to be completed by said electrically conductive member.

10. The electromechanical relay of claim 1, wherein the card structure comprises two contact portions thereon, each of the two contact portions being disposed on opposite sides of a line of symmetry of the card structure.

11. The electromechanical relay of claim 1, wherein the card structure further comprises a first engagement structure and the electromechanical relay further comprises a second engagement structure disposed on a base of the electromechanical relay, the first and second engagement structure configured to engage with each other such that card structure is guided to move substantially along a single axis when the energisable element switches from a non-energised state to an energised state.

12. The electromechanical relay of claim 1, wherein the at least one contact portion is formed of a material selected from a group consisting of ceramic, glass, cemented carbide and combinations thereof.

13. A card structure for use in an electromechanical relay of claim 1, the card structure comprising at least one contact portion for contacting at least one electrically conductive member of the electromechanical relay, wherein the at least one contact portion is formed of a material that has a melting point of no less than 400° C.

14. The card structure of claim 13, wherein the card structure, other than the at least one contact portion, is formed of a material that is different from the at least one contact portion.

15. The card structure of claim 13, wherein the card structure, other than the at least one contact portion, is formed of a material that has a melting point that is less than 350° C.

16. The card structure of claim 13, wherein the card structure, other than the at least one contact portion, is formed of a polymeric material.

17. The card structure of claim 13, wherein the at least one contact portion is formed of a material selected from a group consisting of ceramic, glass, cemented carbide and combinations thereof.

18. The card structure of claim 13, wherein the at least one contact portion forms at least part of a circumference that defines an aperture of the card structure.

19. The card structure of claim 13, wherein the contact portion is dimensioned to substantially prevent the electrically conductive member of the electromechanical relay from contacting any other part of the card structure when in use.

20. The card structure of claim 13, wherein the contact portion is a detachable component of the card structure.

21. The card structure of claim 13, wherein the card structure comprises two contact portions thereon, each of the two contact portions being disposed on opposite sides of a line of symmetry of the card structure.

22. The card structure of claim 13, wherein the card structure is substantially free of polymeric material polyamide 6T and polyphenylene sulfide (PPS).

23. The card structure of claim 13, wherein the card structure further comprises a first engagement structure for engaging a second engagement structure disposed on a base of an electromechanical relay such that the card structure is guided to move substantially in a single direction when an energisable element of the electrometrical relay switches from a non-energised state to an energised state.
